(19) United States
(12) Patent Application Publication
(10) Pub. No.: US 2024/0044346 A1
(43) Pub. Date: Feb. 8, 2024

(54) HYDRAULIC CYLINDER POSITION CONTROL FOR LIFTING AND LOWERING TOWED IMPLEMENTS

(71) Applicant: Ag Leader Technology, Ames, IA (US)

(72) Inventors: Alan F. Barry, Nevada, IA (US); Scott Eichhorn, Ames, IA (US)

(21) Appl. No.: 18/229,974

(22) Filed: Aug. 3, 2023

Related U.S. Application Data
(60) Provisional application No. 63/394,843, filed on Aug. 3, 2022.

(51) Int. Cl. F15B 21/08; F15B 15/14; A01B 63/00

(52) U.S. Cl. CPC F15B 21/08; F15B 15/14; A01B 63/002

(57) ABSTRACT

The disclosed apparatus, systems and methods relate to a hydraulic control system, comprising, the control system having a control unit configured to be in operational communication with a plurality of gauge wheel assemblies, a plurality of cylinders in operational communication with the plurality of gauge wheel assemblies, and a plurality of position sensors in operational communication with the plurality of cylinders, wherein the control unit comprises a feedback position command loop configured to calculate cylinder position error and issue valve commands.

### CROSS-REFERENCE TO RELATED APPLICATION(S)

This application claims priority to U.S. Provisional Application No. 63/394,843 filed Aug. 3, 2022 and entitled “Hydraulic Cylinder Position Control for Lifting and Lowering Towed Implements,” which is hereby incorporated by reference in its entirety under 35 U.S.C. § 119(e).

### TECHNICAL FIELD

The disclosure relates to a hydraulic control system that uses position sensors individual cylinders having and electronic control valves to adjust the extension and retraction rate of the hydraulic cylinders that lift and lower towed agricultural implements. This will replace the mechanical interconnections and/or specialized hydraulic components that are currently required to ensure that the machine lifts and lowers level regardless of the loading conditions or terrain. This will simplify the mechanical design of the lifting mechanism. Control of the hydraulic cylinder movement and constant monitoring of the hydraulic cylinder position will add features of value to the user and assist in modern applications such as autonomous farming.

### BACKGROUND

Agricultural implements that are towed by a tractor typically use a series of tires and mounting structures distributed across the width of the machine to carry the total weight of the machine when the soil engaging tools are lifted out of the soil and to set the operating height of the implement toolbar when in its use position. In many cases, particularly on wider machines such as planters and application equipment, the tool bar has several sections that flex to accommodate uneven terrain. In those instances, the tires gauge the height of the toolbar and average out the changes in the terrain to maintain a useable toolbar height over rises and through valleys in the field. The tires are often called gauge tires for that reason. Frequently, hydraulic cylinders are used as actuators to change the distance between the gauge wheels and the toolbar to accommodate end turns, positioning, and transporting. In these situations, it is important that all the cylinders distributed across the width of the toolbar extend and retract in unison regardless of how weight is distributed on the toolbar or how uneven the terrain is.

Additionally, larger implements need to be reconfigured to allow the implement to be safely transported on public roadways and to pass through gates and the like. In these situations, additional control valves can be added to the hydraulic system to cause some hydraulic cylinders to extend beyond the normal field use position while other hydraulic cylinders may be caused to retract to fully raise a tire off the surface if it is not used in the transport configuration.

To accomplish the various functions and others, the hydraulic system can become complicated with many hoses, valves, and specifically designed hydraulic cylinders used. For example, master/slave hydraulic cylinder pairs are sometimes used to ensure that the machine lifts and lowers evenly, as is shown for example in FIG. 3.

Flow dividers are occasionally used to cause pairs of hydraulic cylinders extend and retract in unison. Mechanical methods such as torsion shafts or common axles are sometimes used to ensure that the hydraulic cylinders extend and retract in unison.

Such methods have been proven to be effective, but they can add to the cost of the machine.

Flow dividers work by splitting the oil flow presented it into two equal flows regardless of the back pressure created by each lifting cylinder. Flow dividers add cost and complexity to the hydraulic system.

Mechanical connections between gauge wheels are sometimes possible but not always. The mechanism can interfere with the soil engaging tool and the structure of the tie needs to be strong enough to withstand torsional loads generated by the actuating cylinders.

Toolbars with soil engaging tools that are intended to operate at higher travel speeds also need to lift for end turns and lower at re-entry at faster rates as well to maximize the productivity of the operation.

Many toolbar gauge wheel designs include a series of wheel position holes in the wheel mounting arm. This is so the operating height of the toolbar can be adjusted to ensure that the soil engaging tool is operating at its optimal design position. In soft soil, for example, the gauge wheels may sink in further and cause the tool bar to operate a lower vertical height. In that case the gauge wheel can be installed in a lower position hole to carry the toolbar higher

There is a need in the art for improved solutions for towed implements. The disclosure addresses the concerns about hydraulic system complexity, cost, and allows for the use of smaller volume hydraulic cylinders because each of the cylinders can contribute equally and independently to the lifting capacity of the machine, and in the event that certain cylinders require more pressure, that can be provided via the described control system. Additionally, when the immediate position of the cylinder extension is known there are many features that can be added using the control system while keeping the mechanical and hydraulic systems simple.

### BRIEF SUMMARY

Described herein are various embodiments relating to devices, systems and methods for controlling a hydraulic system. Although multiple embodiments, including various devices, systems, and methods of controlling the hydraulics are described herein as a “system,” this is in no way intended to be restrictive.

In the various Examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In Example 1, a hydraulic control system, comprising, the control system comprising a control unit configured to be in operational communication with a plurality of gauge wheel assemblies, a plurality of cylinders in operational communication with the plurality of gauge wheel assemblies, and a plurality of position sensors in operational communication with the plurality of cylinders.

In Example 2, the hydraulic control system of Example 1, wherein the control unit comprises a feedback position command loop configured to calculate cylinder position error and issue valve commands.

In Example 3, the hydraulic control system of any of Examples 1-2, wherein the control unit is configured to calculate position error from a measured cylinder position error and a target cylinder position.

In Example 4, the hydraulic control system of any of Examples 1-3, wherein the calculated position error is compared to threshold.

In Example 5, the hydraulic control system of any of Examples 1-4, wherein the feedback position command loop comprises a proportional integral (PI) control loop

In Example 6, the hydraulic control system of any of Examples 1-5, wherein the feedback position command loop is configured to calculate velocity error.

In Example 7, the hydraulic control system of any of Examples 1-6, wherein the feedback position command loop is configured to direct increased relative flow rate via a change in pulse-width modulation (PWM) command.

In Example 8, a hydraulic control system comprising a plurality of gauge wheel assemblies, each of the plurality of gauge wheel assemblies comprising a cylinder in fluidic communication with a PMV valve, and a position sensor in operational communication with the cylinder configured to generate position data, a control unit in operational communication with the position sensors and PMV valves, the control unit comprising a feedback position control system configured to define a target position, receive position sensor data from the position sensor to measure actual position, calculate a position error from the target position, compare the position error to a threshold, and command PMV valves if the position error exceeds the threshold.

In Example 9, the hydraulic control system of Example 8, wherein the control unit comprises a processor, memory and software configured to execute the feedback position control system.

In Example 10, the hydraulic control system of any of Examples 8-9, wherein the feedback position control system is comprises one or more of a position control PI loop and a nested velocity control PI loop.

In Example 11, the hydraulic control system of any of Examples 8-10, wherein the feedback position control system is configured to calculate velocity error from actual velocity and target velocity.

In Example 12, the hydraulic control system of any of Examples 8-11, further comprising a performance model.

In Example 13, the hydraulic control system of any of Examples 8-12, wherein the performance model is configured to identify potential failures, modify thresholds or adjust control loop parameters.

In Example 14, the hydraulic control system of any of Examples 8-13, wherein the feedback position command loop is configured to calculate velocity error.

In Example 15, a hydraulic control system comprising a control unit in operational communication with a gauge wheel assembly comprising a cylinder in fluidic communication with a valve and a position sensor in operational communication with the cylinder configured to generate position data, and a feedback position control system configured to define a target position, measure actual position, calculate a position error from the target position, and command the valve to increase or decrease flow to the cylinder from the position error.

In Example 16, the hydraulic control system of Example 15, the feedback position control system is configured to execute one or more of a position control PI loop and a nested velocity control PI loop.

In Example 17, the hydraulic control system of any of Examples 15-16 comprising a plurality of gauge wheel assemblies.

In Example 18, the hydraulic control system of any of Examples 15-17, wherein the feedback position control system is configured to regulate hydraulic flow between the plurality of gauge wheel assemblies by determining one or more lagging cylinders.

In Example 19, the hydraulic control system of any of Examples 15-18, wherein the feedback position control system is configured to increase pressure in the on or more lagging cylinders.

In Example 20, the hydraulic control system of any of Examples 15-19, further comprising a model-based feed-forward control system configured to determine a predicted load.

Other embodiments of this aspect include corresponding computer systems, apparatus, and computer programs recorded on one or more computer storage devices, each configured to perform the actions of the methods.

Implementations of the described techniques may include hardware, a method or process, or computer software on a computer-accessible medium. While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a side view of an exemplary embodiment of the gauge wheel assembly, according to certain implementations.

FIG. 2 is a schematic view of a prior art hydraulic system.

FIG. 3A is a three-quarters side view of a gauge wheel assembly in a retracted position, according to certain implementations.

FIG. 3B is a three-quarters side view of a gauge wheel assembly in an extended position, according to certain implementations.

FIG. 4A is a three-quarters side view several gauge wheel assemblies in a unified operation position, according to certain implementations.

FIG. 4B is a three-quarters side view several gauge wheel assemblies in a travel configuration position, according to certain implementations.

FIG. 5A is a schematic overview of the control unit component architecture, according to certain implementations.

FIG. 5B is a schematic overview of the control system hydraulic architecture, according to certain implementations.

FIG. 6A depicts a feedback position command loop, according to one implementation.

FIG. 6B is a schematic overview of the control system hydraulic architecture, according to further implementations.

FIG. 7 depicts the control system executing a feedback position command loop, according to one implementation.

FIG. 8 depicts the control system executing a feedback position command loop, according to one implementation.

FIG. 9 depicts the control system executing a feedback position command loop, according to one implementation.

FIG. 10 depicts the control system executing a feedback position command loop, according to one implementation.

FIG. 11 depicts the control system executing a feedback position command loop, according to one implementation.

FIG. 12 depicts the control system executing a feedback position command loop learning model, according to one implementation.

FIG. 13 depicts the control system executing a feedback position command loop learning model, according to one implementation.

FIG. 14 depicts a workflow of the control system, according to one implementation.

### DETAILED DESCRIPTION

This disclosure relates to the devices, systems and methods for a control system 10 and the use of one or more gauge wheel/lift wheel assemblies 12 mounted on a toolbar 14 that are coupled with hydraulic cylinder(s) 16, a position sensor 18, and electronically controlled hydraulic valve(s) 20. In various implementations, these hydraulic cylinder(s) 16 are in operational communication or fluidic with the control system 10, position sensor(s) 18 and valve(s) 20 so as to allow the control system 10 to monitor the position of the individual cylinder(s) 16 to direct hydraulic flow via the valve(s) 20 to individually control the position of the assemblies 12 relative to the toolbar 14 and ground. In various implementations, the position sensor(s) 18 are configured to determine cylinder position sensor data from the cylinder, which can include actual position, actual velocity and the like, as described herein. This position sensor data may variously be referred to herein as “actual position,” “actual velocity” and the like.

That is, in various implementations, the system 10 allows for the individual control of the assemblies 12 to account for real-world conditions and execute specified commands on a row-by-row level. In certain implementations, for example, the system 10 is able to identify individual assemblies that have not extended or retracted as commanded via the position sensor(s) 18 and direct hydraulic flow to those assemblies 12 to bring all of the assemblies 12 into alignment, as will be explained further herein.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/081,432, filed Dec. 14, 2022, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/215,721, filed Jun. 28, 2023, entitled “Seed Tube Guard and Associated Systems, Devices, and Methods of Use,” U.S. Patent Application 63/394,843, filed Aug. 3, 2022, entitled “Hydraulic Cylinder Position Control for Lifting and Lowering Towed Implements,” U.S. Patent Application 63/395,061, filed Aug. 4, 2022, entitled “Seed Placement in Furrow,” U.S. Patent Application 63/400,943, filed Aug. 25, 2022, entitled “Combine Yield Monitor,” U.S. Patent Application 63/406,151, filed Sep. 13, 2022, entitled “Hopper Lid with Magnet Retention and Related Systems and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” U.S. Patent Application 63/445,550, filed Feb. 14, 2023, entitled “Liquid Flow Meter and Flow Balancer,” U.S. Patent Application 63/466,144, filed May 12, 2023, entitled “Devices, Systems, and Methods for Providing Yield Maps,” and U.S. Patent Application 63/466,560, filed May 15, 2023, entitled “Devices, Systems, and Methods for Agricultural Guidance and Navigation,” U.S. Patent Application 63/524,065, filed Jun. 29, 2023, entitled “Ring Assembly,” and U.S. Patent Application 63/525,525, filed Jul. 7, 2023, entitled “Assisted Steering Systems and Associated Devices and Methods for Agricultural Vehicles,” each of which is incorporated herein by reference.

Returning to the disclosed control system 10, the various implementations described herein utilize real-time or near-real-time position sensor data to control the application of hydraulic pressure to the gauge wheel assemblies of an implement to control the extension and retraction of those wheel assemblies. It is understood that as the overall hydraulic system pressure is established by the tractor and is normally equal at all cylinders and control valves, and that the various implementations of the system 10 are configured to utilize the various control valves to adjust the flow rate at system pressure to increase or decrease the discrete pressure applied to, and correspondingly the travel speed of, individual cylinders based on position sensor feedback. Discussion of changes in “pressure” contained herein should be understood as such.

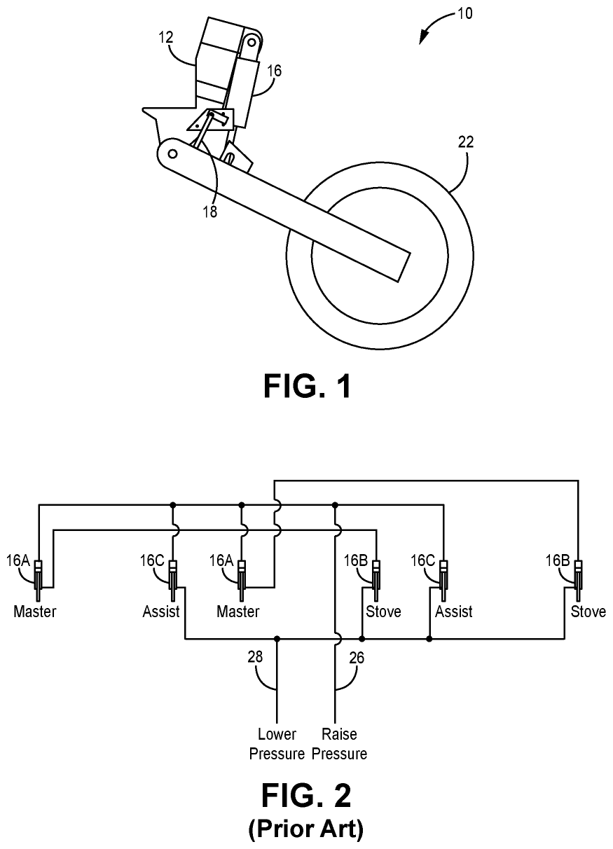

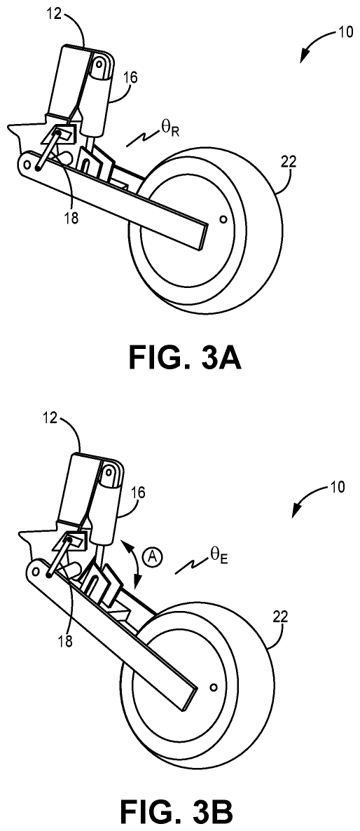

FIG. 1 depicts an implementation of a gauge wheel/lift wheel assembly 12 coupled to a cylinder 16 with a position sensor 18 and linkage added, according to certain implementations. FIG. 2 depicts a typical design of a conventional hydraulic lift circuit 2 on a wing fold planter (not shown) using two master cylinders 16A, two slave cylinders 16B, and two assist cylinders 16C. It is appreciated that in use, a manually operated valve (not shown) locks the outboard cylinders in a retracted position so the machine can be transported.

In the prior art, master/slave hydraulic systems like the one shown in FIG. 2 often use custom designed hydraulic cylinders so the volume of hydraulic fluid leaving the master cylinder as it extends matches the volume of oil required to extend the slave cylinder at the same rate as the master. With this type of system, it is necessary to provide a means to ensure that the cylinders are in time (fully retracted and/or fully extended) with each other and that all the air can be purged from the system. This is called rephasing and adds further complexity to the design of the hydraulic cylinder. Also, the slave cylinder does not add to the lifting capacity of the system because it is a load on the master. A master/slave hydraulic system can only lift the weight that the master can lift by piston area and the mechanical lifting geometry.

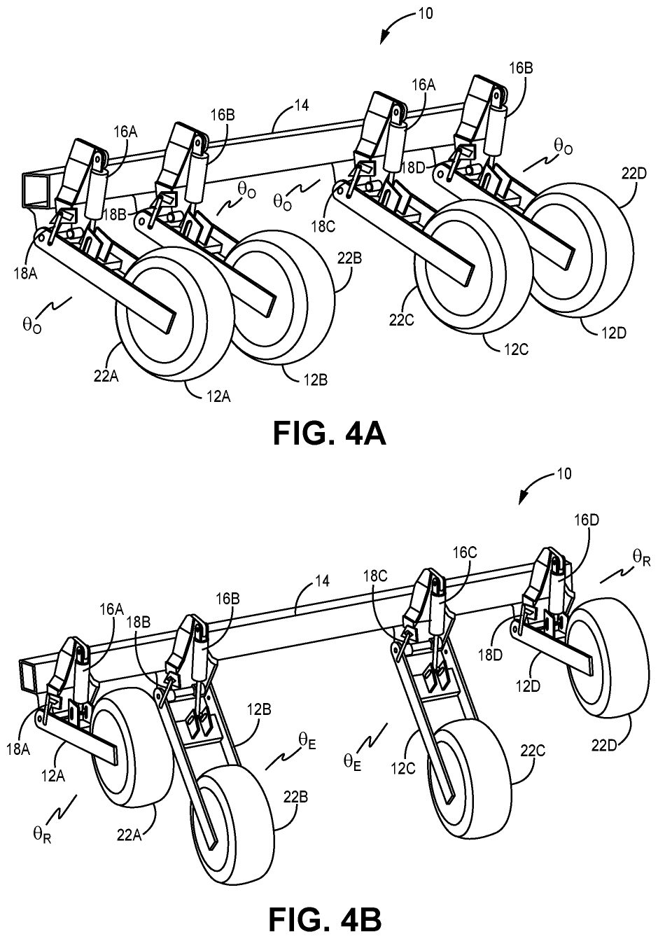

In contrast, and as shown in FIGS. 3A-3B, the control system 10 implementations disclosed herein allow for the independent control of the extension and retraction of the various gauge wheel assemblies 12. FIGS. 3A-3B each depict a gauge wheel/lift wheel assembly 12 with a position sensor and linkage installed according to certain implementations, first in a raised angle/position θ_{R} (FIG. 3A) and then in an extended (FIG. 3B) angle/position θ_{E}, wherein the gauge wheel assembly 12 is rotated about reference arrow A between these positions via the extension or retraction of the cylinder 16, as would be readily understood. While this implementation contemplates a raised θ_{R} position and an extended θ_{E} position, this simply for illustration—it is appreciated that the angular position or angle of the various assemblies 12 can be adjusted on a continuum from a fully raised position θ_{R} to fully extended θ_{E} through a range of operational positions θ_{O}, and that while reference is being made herein to changes in angle θ, it is of course understood that the position sensors 18 utilized may be measuring angle, linear position, rotational position, wheel arm position, arc or other position determinations readily understood by the skilled artisan, and that the output from these various sensors would have a defined mathematical relationship that is appropriately correlated to an input that can be used by the system to effectuate the processes and systems disclosed herein.

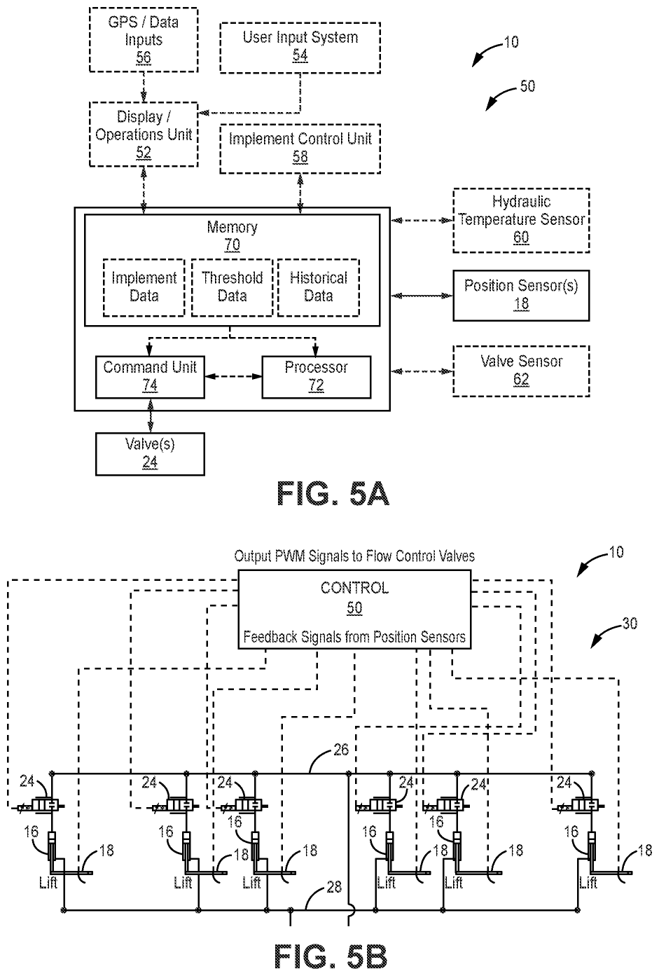

In an exemplary implementation of the system, FIGS. 4A-4B show a toolbar 14 assembly with four gauge wheel/lift wheel assemblies 12A, 12B, 12C, 12D installed. Each assembly 12A, 12B, 12C, 12D has an independently-operated cylinder 16A, 16B, 16C, 16D with its own position sensor 18A, 18B, 18C, 18D. In the implementation of FIG. 4A, all four wheel assemblies 12A, 12B, 12C, 12D are in an operational position θ_{O} and can be configured to move in unison to distribute weight to all four tires 22, as would be understood. As shown in FIG. 4B, two of the assemblies 12A, 12D have been commanded to be raised into the raised position θ_{R} and two of the assemblies 12B, 12C have been commanded to be extended into the extended position θ_{E} via the system 10 to carry weight in a transport configuration, while the outer two assemblies 12A, 12D are retracted. Many configurations are of course possible. This is of course simply exemplary, and many implementations are of course possible as will be discussed further herein.

Transport folding functions can be simplified and the transition could be made to know if the machine in is an elevated or lowered position at the start so the proper sequence can be implemented. For example, consider a simple wing fold planter with four center tires and the wing tires that must be retracted for transport. If the planter is lowered at the start of the transport sequence, the wing wheels would stay retracted because the electronically controlled valve on those cylinders would remain closed while the center four cylinders are extended. If the planter is raised at the beginning of the transport sequence, the center four cylinders 16 would remain extended while the wing wheels could be retracted.

In various implementations, the toolbar 14 lift height can also be set by stopping the extension of the lift cylinder before it is fully extended, thereby reducing the lift/lower time at turn arounds. Further, in certain implementations, the lift position switch needed on most implements to turn operations on and off can be eliminated.

It is also appreciated that in certain implementations the lift circuit according to certain implementations can be paired to other hydraulic circuits and reduce the need for a tractor remote hydraulic connection, as would be readily understood. An additional valve can optionally be added to reverse the hydraulic flow for the up/down function, as would also be understood.

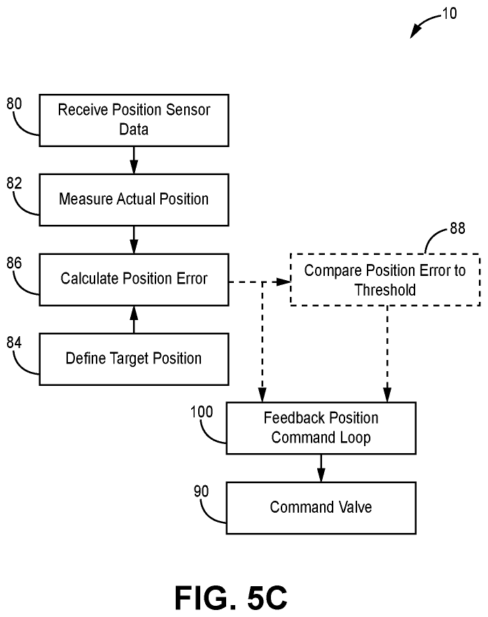

FIGS. 5A-5B depict an overview of the control system 10 according to certain implementations. In FIG. 5A, a control unit 50 is provided that is in electronic and operational communication with various components of the control system 10, implement (not shown) and/or other operations units and components that are interconnected with the system 10, such as an display or operations unit 52 that is mounted in the cab for use by the operator. For example, in certain implementations the control unit 50 is in operational communication with an in-cab display 52, such as the InCommand® display from AgLeader®. In these and other implementations, a graphical user interface (GUI) or input system 54 that can display information related to the control system 10 and assembly position in real-time or near real-time to an operator during operations to allow for the provision of data and information to the operator and allow for the entry of commands, as would be readily understood. Certain implementations are also in operational communication with additional data inputs 56 such as GPS/GNSS data and the like, as is discussed in detail in the incorporated references.

Additionally, the control unit 50 can be optionally in operational communication with various additional data sources for the operations discussed herein, such as optionally any implement control unit(s) 58, hydraulic temperature sensor(s) 60, and/or valve sensor(s) 62. Further inputs are of course possible and would be readily understood, such as gyroscopes and accelerometers and the like, which can be used in conjunction with a GPS/GNSS technologies for precise location or separately for implement orientation, as has been previously-described. Historical data such as previous tractor/cylinder performance can also be utilized by the system, as described elsewhere herein.

Continuing with FIG. 5A, in these implementations the control unit 50 comprises memory 70, a processor 72 and a command unit 74 that is configured to generate and issue commands to the various valves 24 to effectuate the operations directed by the processor 72 and/or control unit 50. It is readily appreciated that an operations system or other programming software or firmware is installed or otherwise utilized to perform the commands discussed herein, and that this may be on one or more of the display 52, memory 70, processor 72 or elsewhere.

As is appreciated, in exemplary implementations of the system 10, the control unit is in operational communication with the various position sensors 18 so as to receive provided position sensor data to determine the actual position of the various assemblies 12 and cylinders 16 being commanded by the system 10.

As shown in FIG. 5B, the control unit 50 is in operational and/or fluidic communication with the various position sensors 18 and cylinders 16/valves 24 of the control system 10 so as to allow for the operation of the system 10 as described. It is further understood that the cylinders 16 and valves 24 are in fluidic communication with the tractor (not shown) or other powered hydraulic system as is well-understood in the art.

In the exemplary implementation of FIG. 5B, the hydraulic architecture 30 of the control system 10 circuit uses independent lift cylinders 16 in parallel having valves 24 and in operational communication with position sensors. It is understood that typical twelve row planter schematics have been simplified and that certain valves 24, both manually operated and remotely operated, have been left out for clarity.

Further, in this implementation of the system 10 the electronic control valves 24 are installed at the extend port of each cylinder 16, along the raise 26 side (and opposite the lower side 28) of the system 10. In turn, the position sensors (shown, for example, at 18 in FIGS. 1-2) monitor the extension length of each cylinder 16 to provide feedback to the control system 10 for the individual control of the cylinders 16 and, accordingly, the gauge wheel/lift wheel assemblies 12. It is appreciated that in various implementations, the valves 24 can be disposed variously throughout the hydraulic system 30.

In various implementations, the control system 10 is thus configured to monitor the extension and retraction position of each actuating cylinder 16 and adjust the flow rate or applied pressure to each cylinder 16 via the various valves 24 so all the cylinders 16 in the lifting system either extend and/or retract at the same rate regardless of the weight on various parts of the machine and regardless of the terrain or are otherwise moved into the commanded position or arrangement efficiently and smoothly.

It is appreciated that in these implementations, the various tolerances can be defined, set by the user and/or adjusted over a defined period, as described herein.

In certain implementations, combinations of controlled position hydraulic cylinders 16 and uncontrolled position assist cylinders 16 can be used to reduce the overall number of position sensors and control valves. It is appreciated that this could be determined by needs to control the cylinder position during transport functions and the need to monitor the system during operation.

As shown generally in FIG. 5C, the control system 10 is configured to receive position sensor data (box 80) to measure one or more ground truth or actual values such as actual position (box 82) and compare them with defined target values (box 84) to calculate one or more cylinder errors such as position error (box 86) that can compared to a threshold (box 88) or deadband to correct the error via the execution of a feedback position command loop 100 and issuance of commands to the valve (box 90). For example, the control system 10 can be configured to determine the actual position of each cylinder 16 and use feedback provided from those cylinders 16 to adjust the commands given to that cylinder and, in certain implementations, the other cylinders via the feedback position command 100 that are executed by the system and which can comprise one or more control loop systems. For example, in certain implementations the feedback position command loop 100 can be used to compare the instantaneous actual position or velocity of a given cylinder to an defined target, or compare it to the other cylinders, and adjusts the flow rate to each cylinder (based on system pressure) via the operations unit and commands issued to valves as needed to affect the unified, controlled motion of the cylinders 16.

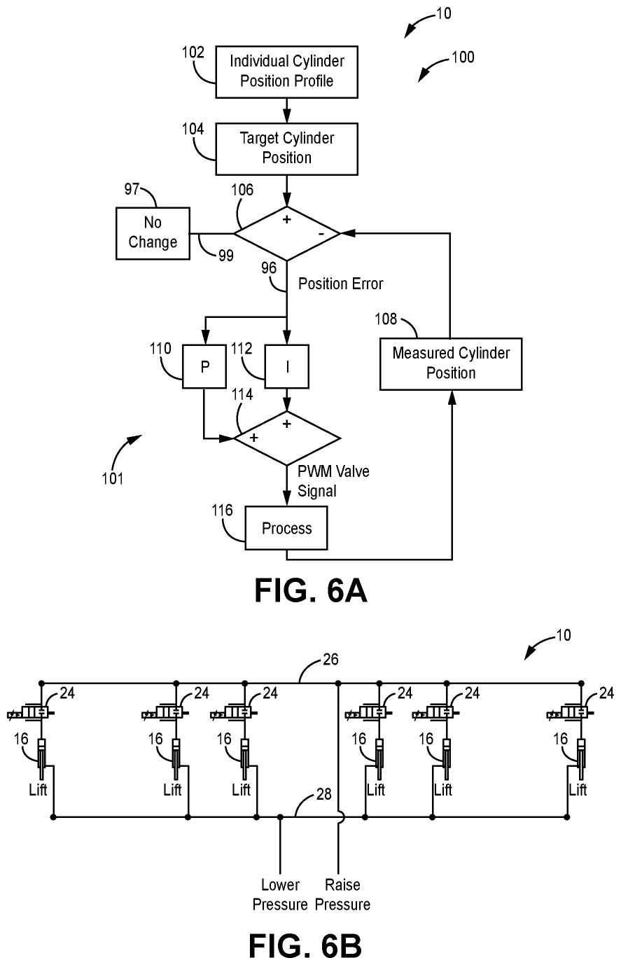

Thus, when the position of each cylinder 16 is always known, there are several features that can be added to the operation of the toolbar function. For example, the toolbar 14 operation height can be set by stopping the retraction of the lift cylinder before it is fully retracted eliminating the need for a mechanical adjustment. This can be important if changing field conditions cause the toolbar to run out of level. Further explanation of exemplary implementations is described in detail in FIGS. 6A-14.

FIG. 6A depicts an exemplary implementation of the control system 10 the described utilizing a feedback position command system 100 to control an individual cylinder 16 on the basis of feedback received from the position sensors and other data provided to the system 10. In this implementation, the feedback position command loop 100 compares an actual position with a defined target position established by the system 10. It is appreciated that in use according to certain implementations, the defined target position changes over time, and that the received position sensor data is processed as a time-series of values.

In the implementation of FIG. 6A, a desired individual cylinder profile (box 102) for the cylinder is given, which can be based on the desired arrangement and position of the assemblies based on historical performance, programmed commands, user input or the like, each individual cylinder has a position that the system 10 will direct the valves to achieve efficiently. For example, if the design of the implement requires some cylinders to extend at a different rate than others to lift the implement properly, the control system 10 can be configured to cause that controlled motion by assigning differentiated profiles to specific sets of cylinders.

In the implementation of FIG. 6A, for example, the profile (box 102) is inputted as a defined target position (box 104), which can be compared to the actual position (box 108) of the cylinder based on the time-series position sensor data derived from the position sensor 18 on the cylinder over time to calculate a position error (box 106). According to certain implementations, the position error (box 106) is calculated by comparing the measured cylinder position (box 108) to the target cylinder position (box 104) to calculate a position error value. In the event that a non-zero position error (or position error which exceeds a defined threshold or deadband) is detected, the system 10 proceeds to execute a proportional integral (PI) control loop 101 (shown at line 98). While a PI control loop is one such example of a feedback control loop, other similar loops are of course possible, as would be understood.

It is understood that in the event that there is no position error, or if it is within a defined deadband or threshold established by the system and/or user (shown at line 99), no change in action (box 97) will be commanded. It is further understood that the calculation of position error (box 106) in these and other implementations is performed continuously overtime such that while the implement is being activated, the position error may change continually.

In use according to these implementations, in the event that a position error is present (line 98), the PI control loop 101 is able to direct increased relative flow rate via a change in pulse-width modulation (PWM) command to the lagging assembly 12 and increase the cylinder's rate of extension or retraction via proportional (box 110) and integral (box 112) control commands that are combined (box 114) and issued to command a change in PWM valve signal to the cylinders (shown in real-time execution as Process, box 116). It is understood that actual cylinder position (box 108) continues to be recorded and that the control system 10 and feedback position command loop 100 both continue to proceed as described. Those of skill in the art will appreciate that the combination of proportional and integral control can provide both immediate and persistent adjustment to lagging cylinders in certain implementations, but in further implementations additional feedback control systems and approaches can also be incorporated as appropriate.

That is, while these implementations utilize one version of a PI control loop, it is well-appreciated that other implementations can use alternate PI control configurations, proportional integral derivative (PID) loop configurations, and other control loop feedback mechanisms as would be well-appreciated in the art.

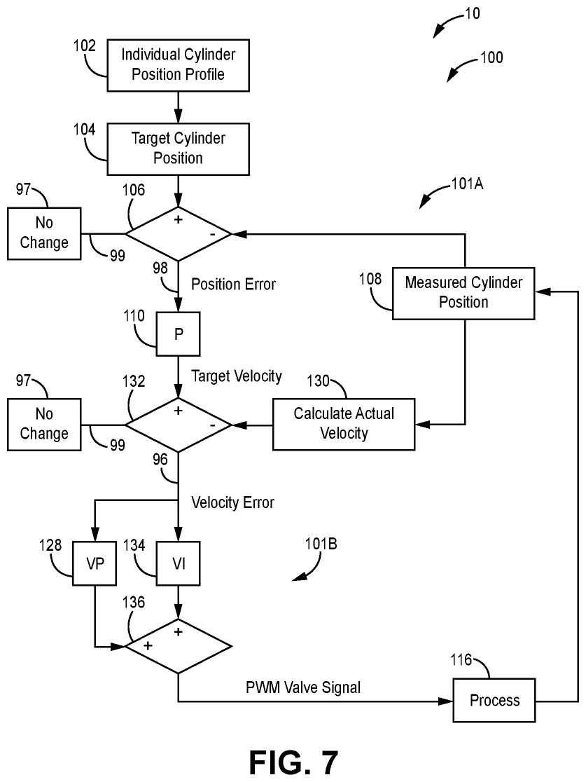

In the exemplary implementation of FIG. 7, the control system 10 utilizes a feedback position command loop 100 comprising a position control PI loop 101A where the target position (box 104) and measured position (box 106) are compared, and if the result is non-zero or in excess of a defined deadband or threshold (line 98), a nested velocity control PI loop 101B is executed, wherein the position error (box 106) is inputted into a proportional control (box 110) to establish a target velocity that is compared to the actual velocity (box 130) derived from the measured cylinder position (box 108) to calculate a velocity error (box 132), which (if not non-zero or within defined deadband/thresholds, line 99) is inputted (line 96) into the velocity control loop 101B.

In the velocity control loop 101B, the proportional of the velocity control loop (box 128) and integral of the velocity control loop (box 134) are combined (box 136) to command a PWM signal to the control valve to minimize velocity error. In this control system 10 implementation, it is appreciated that larger position errors will correspond to larger target velocity and accordingly higher PMV signals. And in turn, these higher velocities will more quickly eliminate the position error.

As an illustrative example of the application of the use of such a feedback position command loop 100, take a given cylinder currently at the desired cylinder position of 1″ extension at zero velocity. Under these conditions, the cylinder has zero position error (box 106) and zero velocity error (box 132), and as such no change is required to the command. Subsequently, the operator issues a command (such as from the display or other in-cab system) defining the target position (box 104) to 10″ of extension for this cylinder. As the cylinder is at 1″, the position error is now instantly at of 9″. This error (box 106) passes to a P-gain action at the proportional (box 110) that generates a proportional target velocity. In this instance, assume a P-gain of 2×. Accordingly, the target velocity is 9*2=18. Actual velocity is still zero, so the velocity error is 18−0=18. The velocity P and I actions (boxes 128 and 134) will therefore generate a corresponding PWM signal for the valve to increase hydraulic flow or pressure maximally.

After a period of time, the cylinder is now moving toward the defined target position. It's currently at 4″ and the target is still 10″. Position error is 10″−4″=6″. Target velocity is position error*P-gain. 6*2=12. Assume current velocity is 13, so velocity error is 12−13=−1. So the PWM signal will be reduced accordingly. As the cylinder continues to approach the target position, the target velocity will steadily reduce, until target velocity drops to zero when the cylinder reaches 10″. It is thus appreciated that in a population with a relatively limited overall hydraulic capacity, such differences in commands at the individual cylinders thus results an efficient allocation of pressure and more immediate response in the system. It is further appreciated that this is given to demonstrate one illustrative example according to an application of the implementation of FIG. 7, but is in no way intended to be limiting.

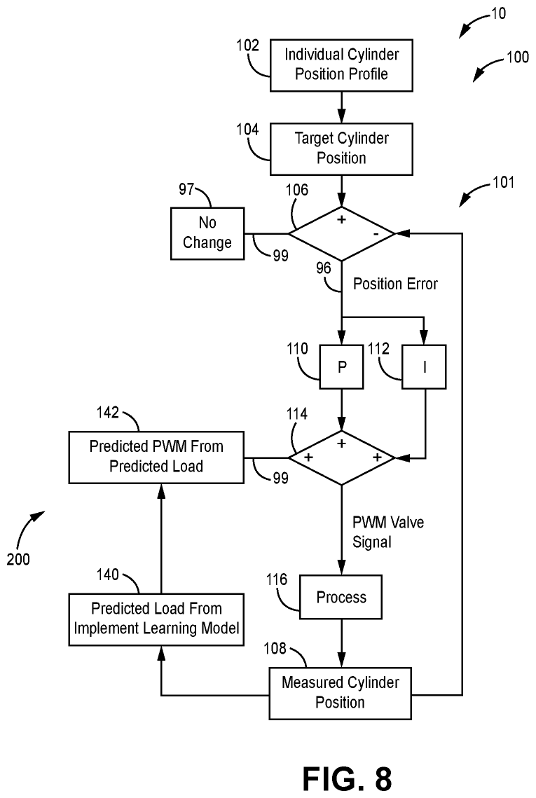

Returning to the figures, in the implementation of FIG. 8, the control system 10 comprises a feedback position command loop 100 having a PI control loop 101 where in the event of a detected position error (box 106), the position error is inputted for application of proportional (box 110) and integral (box 112) control commands and the actual cylinder position (box 108) is also inputted into a model-based feed-forward control system to determine a predicted load (box 140) via an implement learning model, which can in turn be used to predict the pulse wave modulation (box 142) which can be combined with the proportional (box 110) and integral (box 112) control commands to modify the PWM valve signal (box 114) and execute the process (box 116), as would be appreciated. It is appreciated that in such implementations the system 10 thereby makes use of a learning or performance model 200 to optimized system 10 performance. Further implementations can make use of additional model predictive control technologies, such as a learning-based model predictive controller and the associated and similar approaches. In various implementations, the performance model can be configured to identify potential failures, modify thresholds or adjust control loop parameters, such as the proportional and integral controls for position and/or velocity.

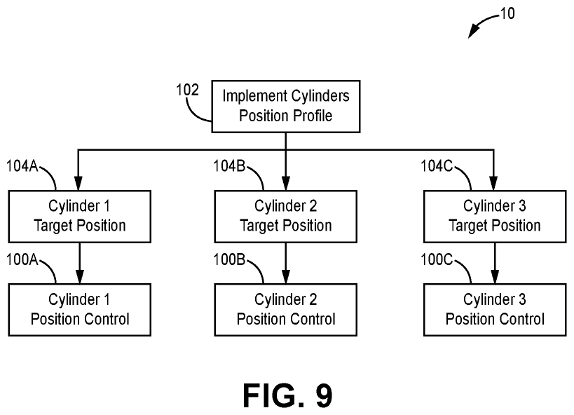

In the implementation of FIGS. 9-11, the control system utilizes position profiles (box 102) to coordinate a plurality of cylinders moving as a group. In these implementations, the target positions (boxes 104A, 104B, 104C) for several cylinders are established together and the system 10 utilizes position control (boxes 100A, 100B, 100C) on the cylinders to accomplish unified or otherwise coordinate movement.

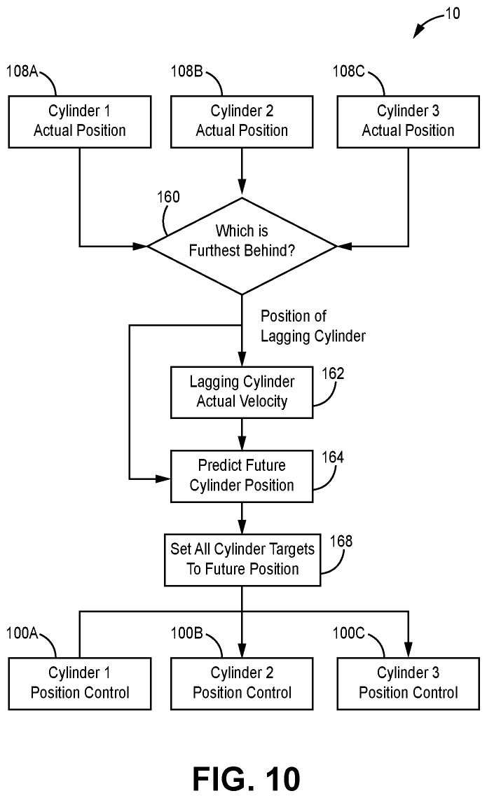

In the implementation of FIG. 10, the position command system 100 can be performed on several coordinated cylinders. In these implementations, for example, the actual positions of the cylinders based on the time-series position sensor data (boxes 108A, 108B, 108C) can be compared to establish if there is a lagging cylinder that is “furthest behind” (box 160). Actual velocity of the lagging cylinder can be calculated (box 160, future cylinder position predicted (box 164) and the targets of all cylinders can be adjusted to account for the calculated future positions (box 166), as shown. In various implementations, the flow to the lagging cylinder can accordingly be increased to account for the lag and bring the cylinders into alignment, as would be understood.

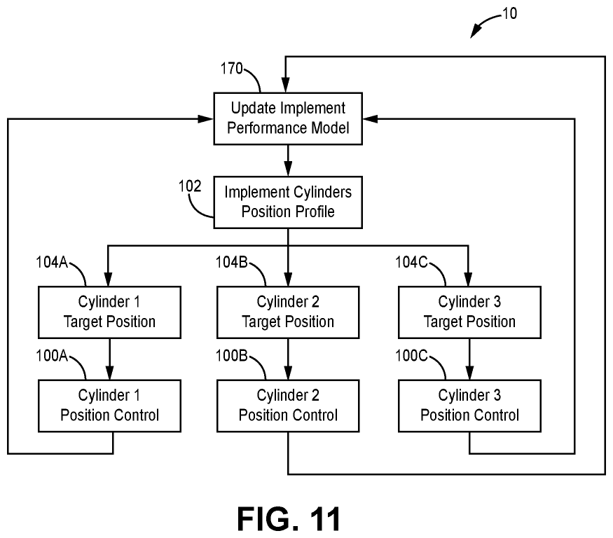

FIG. 11 depicts an implementation of the system 10 wherein a performance model (box 170) is used to establish and update the position profiles (box 102) based on feedback derived from the position control (boxes 100A, 100B, 100C) being inputted (lines 172A, 172B, 172C) into the model (box 170).

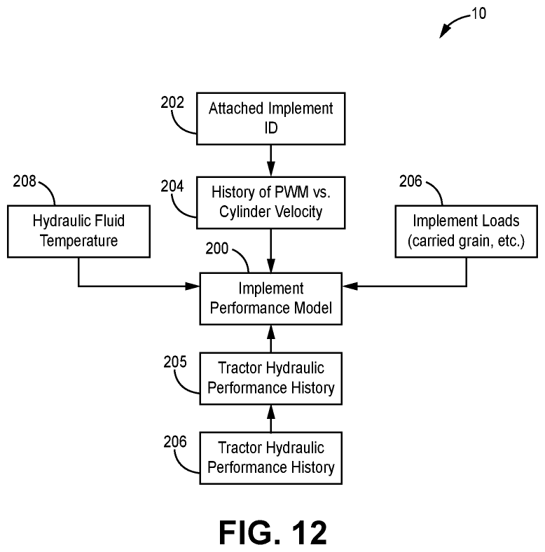

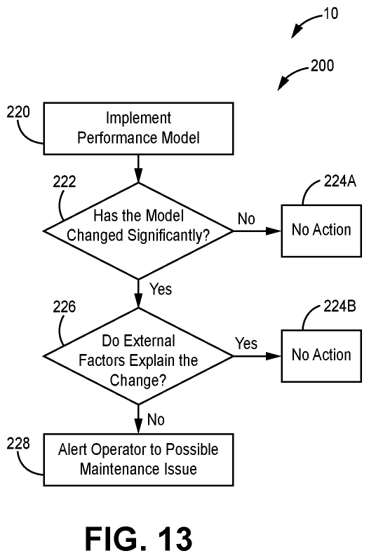

FIGS. 12-13 depict various implementations of a learning implement performance model (box 200) and how it can be utilized by the system 10 to inform an operator of potential maintenance issues. That is, feedback from the control system 10 and/or information about the particular implement and its performance can advise the operator of potential machine failures and service needs. For example, if a particular cylinder 16 is requiring increasing amounts of lift pressure or is becoming increasingly slow to extend θ′ or retract θ over time, a potential bearing failure could be the cause. It is appreciated that this information can be provided to the operator via the display (shown in FIG. 6A at 52) or otherwise.

In the implementation of FIG. 12, the performance model (box 200) is able to utilize various optional data inputs to improve implement performance and uptime. Certain of these data inputs can include the identity of the attached implement (box 202) and, optionally, the historical performance of the PMW vs. actual cylinder velocity (box 204) as, for example recorded by the implement or inputted from more widely available results. Tractor type identity (box 206) and historical hydraulic system performance (box 208) can likewise be inputted into the performance model (box 200).

In various implementations, and as also shown in FIG. 12, real-time readings such as the hydraulic fluid temperature (box 210) and or the implement loads (box 212) can also be inputted into the performance model (box 200) for use in assessing and optimizing the performance of the system 10 and the potential for failure, such as via machine learning or other forms of artificial intelligence, as would be readily appreciated.

FIG. 13 depicts one exemplary implementation of the performance model 200 being executed. It is readily appreciated that many approaches are of course possible. In this implementation, the model is begun (box 220) and queries whether there has been a significant change (box 222). If “no,” no further action is taken (box 224A). If yes, the performance model 200 further queries whether the change can be attributed to external factors (box 226), such as those discussed in relation to FIG. 12 and including but not limited to solenoid coil temperature and resistance, cylinder velocity vs. PWM performance, tractor RPM, hydraulic supply pressure, hydraulic oil life monitor, hydraulic oil filter life monitor, tractor hydraulic oil level, and tractor hydraulic flow rate limit settings, among others that would be readily appreciated in the art. If “yes,” no further action is taken (box 224B). If “no,” the operator is alerted (box 228).

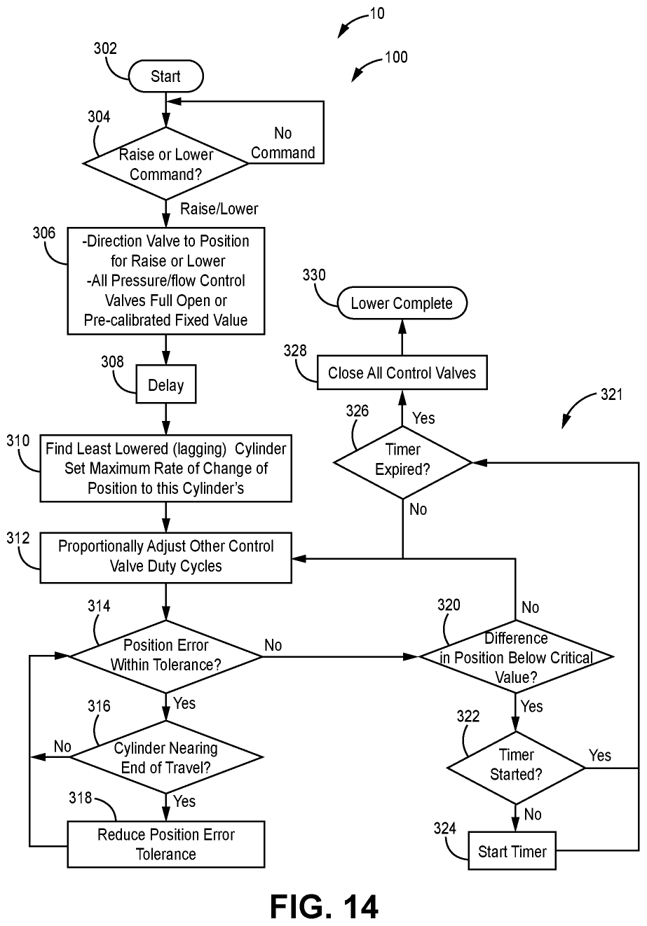

FIG. 14 depicts a flow chart laying out one exemplary sequence of operations of the control system 10 executing a position command system 100 executed by the control system 10 according to certain implementations. In these implementations, the control system 10 is taking in hydraulic cylinder position information and driving the electronic control valves to move all the hydraulic cylinders under controlled conditions. This implementation is intended to be exemplary and in no way limiting to a specific series of steps. As with the other figures, each of the steps and sub-steps described in relation to FIG. 14 can be performed in any order, omitted or substituted for alternate steps as would be readily appreciated.

As shown in FIG. 14, after starting the system (box 302), in one step the system 10 queries whether a raise/lower command has been received (box 304). If “no,” then the system 10 continues to await the receipt of a command. If a command has been received to raise or lower, in a subsequent optional step, the system directs the valves (box 306) which can comprise one or more of positioning the valves for raise/lower functions and/or opening the valves fully or partially, as would be appropriate to achieve the commanded cylinder activity.

In certain optional implementations, the system 10 can delay (box 308) or otherwise hold and/or cycle the operation.

In another optional step, the system 10 addresses lag by identifying (box 310) one or more lagging cylinders and commanding the system to direct flow to those lagging cylinders, such as via the operations unit.

In a further optional step, the non-lagging control valve duty cycles can be proportionally adjusted (box 312) so as to balance flow to account for lagging cylinders, as is explained above and would be appreciated.

The system 10, in a further optional step, can query whether the detected positions/position errors (via the position sensors) are within defined tolerances (box 314); if “yes,” the system 10 proceeds as follows: it queries whether the cylinder is nearing the end of travel (box 316), if “yes,” it reduces the position error tolerance (box 318) and returns to box 314, if “no,” it directly returns to box 314.

Returning to box 314, if the position error is not within tolerances, the system determines whether the difference in position is below a critical value (box 320). If “yes,” the system executes a timer sequence 321, shown by optionally querying whether there is a timer (box 322) and starting a timer (box 324); and then running the timer, shown by querying whether the timer has expired (box 326), subsequently closing the control valves (box 328) and terminating the sequence (box 330).

If the difference in position is not below a critical value (box 320), the system according to these implementations returns to box 314 and proceeds. While FIG. 14 depicts a series of optional steps and subs-steps, and some of which are specifically discussed as “optional,” it is readily appreciated that this is simply one exemplary workflow of the disclosed system 10 and not

It is appreciated that according to certain implementations, no mechanical or hydraulic approach for splitting the hydraulic flow to each cylinder 16 is required. This is advantageous and can simplify the design, make it more modular, and be more efficient by making use of all the mechanical force generated by the cylinders 16. Further, the cylinders 16 can be made of a smaller bore and can all be the same design, as opposed to typical prior art approaches.

Although the disclosure has been described with reference to preferred embodiments, persons skilled in the art will recognize that changes may be made in form and detail without departing from the spirit and scope of the disclosed apparatus, systems and methods.

What is claimed is:

1. A hydraulic control system, comprising, the control system comprising:
a. a control unit configured to be in operational communication with a plurality of gauge wheel assemblies;
b. a plurality of cylinders in operational communication with the plurality of gauge wheel assemblies; and
c. a plurality of position sensors in operational communication with the plurality of cylinders.

2. The hydraulic control system of claim 1, wherein the control unit comprises a feedback position command loop configured to calculate cylinder position error and issue valve commands.

3. The hydraulic control system of claim 2, wherein the control unit is configured to calculate position error from a measured cylinder position error and a target cylinder position.

4. The hydraulic control system of claim 3, wherein the calculated position error is compared to threshold.

5. The hydraulic control system of claim 2, wherein the feedback position command loop comprises a proportional integral (PI) control loop

6. The hydraulic control system of claim 2, wherein the feedback position command loop is configured to calculate velocity error.

7. The hydraulic control system of claim 2, wherein the feedback position command loop is configured to direct increased relative flow rate via a change in pulse-width modulation (PWM) command.

8. A hydraulic control system comprising:
a) a plurality of gauge wheel assemblies, each of the plurality of gauge wheel assemblies comprising:
i) a cylinder in fluidic communication with a PMV valve; and
ii) a position sensor in operational communication with the cylinder configured to generate position data;
b) a control unit in operational communication with the position sensors and PMV valves, the control unit comprising a feedback position control system configured to:
define a target position;
receive position sensor data from the position sensor to measure actual position;
calculate a position error from the target position;
compare the position error to a threshold; and
command PMV valves if the position error exceeds the threshold.

9. The hydraulic control system of claim 8, wherein the control unit comprises a processor, memory and software configured to execute the feedback position control system.

10. The hydraulic control system of claim 8, wherein the feedback position control system is comprises one or more of a position control PI loop and a nested velocity control PI loop.

11. The hydraulic control system of claim 8, wherein the feedback position control system is configured to calculate velocity error from actual velocity and target velocity.

12. The hydraulic control system of claim 8, further comprising a performance model.

13. The hydraulic control system of claim 12, wherein the performance model is configured to identify potential failures, modify thresholds or adjust control loop parameters.

14. The hydraulic control system of claim 12, wherein the feedback position command loop is configured to calculate velocity error.

15. A hydraulic control system comprising:
a) a control unit in operational communication with a gauge wheel assembly comprising:
i) a cylinder in fluidic communication with a valve; and
ii) a position sensor in operational communication with the cylinder configured to generate position data; and
b) a feedback position control system configured to:
define a target position;
measure actual position;
calculate a position error from the target position; and
command the valve to increase or decrease flow to the cylinder from the position error.

16. The hydraulic control system of claim 15, the feedback position control system is configured to execute one or more of a position control PI loop and a nested velocity control PI loop.

17. The hydraulic control system of claim 15 comprising a plurality of gauge wheel assemblies.

18. The hydraulic control system of claim 17, wherein the feedback position control system is configured to regulate hydraulic flow between the plurality of gauge wheel assemblies by determining one or more lagging cylinders.

19. The hydraulic control system of claim 18, wherein the feedback position control system is configured to increase pressure in the on or more lagging cylinders.

20. The hydraulic control system of claim 18, further comprising a model-based feed-forward control system configured to determine a predicted load.
